(19) United States
(12) Patent Application Publication
(10) Pub. No.: US 2026/0119682 A1
(43) Pub. Date: Apr. 30, 2026

(54) COMPUTER DEVICE FOR PROTECTING DATA OF AN OPERATING SYSTEM KERNEL

(71) Applicant: HUAWEI TECHNOLOGIES CO., LTD., Shenzhen (CN)

(72) Inventors: Qiming Li, Helsinki (FI); Kui Wang, Helsinki (FI)

(73) Assignee: HUAWEI TECHNOLOGIES CO., LTD., Shenzhen (CN)

(21) Appl. No.: 19/433,242

(22) Filed: Dec. 26, 2025

Related U.S. Application Data
(63) Continuation of application No. PCT/EP2023/067387, filed on Jun. 27, 2023.

(51) Int. Cl. G06F 21/60

(52) U.S. Cl. CPC G06F 21/602; G06F 21/604

(57) ABSTRACT

A computer device for protecting data of an operating system kernel determines a security context based on at least one of: a memory address of a container kernel data structure, a memory address of a kernel data field within the container kernel data structure, and a memory address of a kernel pointer within the container kernel data structure. The kernel data field or the kernel pointer is signed based on the security context and a signing instruction to obtain a security tag. The security tag is added to the container kernel data structure.

### CROSS-REFERENCE TO RELATED APPLICATIONS

This application is a continuation of International Application No. PCT/EP2023/067387, filed on Jun. 27, 2023, the disclosure of which is hereby incorporated by reference in its entirety.

### FIELD

Embodiments of the disclosure relate to a computer device for protecting data of an operating system kernel. Furthermore, embodiments of the disclosure also relate to a corresponding method and a computer program.

### BACKGROUND

It is commonly seen nowadays that consumer devices such as smart phones may contain sensitive data such as personal data, credit card numbers, passwords, etc. These devices are also used for secure transactions such as payment, secure email, end-user authentication and authorization, and alike. To protect user privacy for such use cases, it is important to maintain the integrity of the operating system (OS) kernel, which is responsible for allocating resources for applications and controlling access to the resources.

The operating system kernel in a consumer device may be compromised in a number of ways. An attacker may attempt to modify the executable code of the OS kernel, e.g., by injecting malicious code or modifying existing code via a vulnerability found in the kernel. Besides directly modifying the executable code of the kernel, there are other subtle ways to change the behavior of the kernel by only modifying the data during runtime. For example, an attacker may find a way to change the memory address of the code that the central processing unit (CPU) is going to execute next via a memory vulnerability, such as buffer overflow. By manipulating the sequence of code execution, the attacker may be able to find a number of code segments (called gadgets) such that when stitched together, the resulting code sequence exhibits malicious behaviors desired by the attacker. Such attacks are often referred to as return-oriented programming (ROP) or jump-oriented programming (JOP) depending how the actual techniques used.

### SUMMARY

Embodiments of the present disclosure provide a solution which mitigates or solves the drawbacks and problems of conventional solutions.

According to a first aspect, the present disclosure provides a computer device for protecting data of an operating system kernel, the computing device being configured to:
determine a security context based on at least one of: a memory address of a container kernel data structure, a memory address of a kernel data field within the container kernel data structure, and a memory address of a kernel pointer within the container kernel data structure;
sign the kernel data field or the kernel pointer based on the security context and a signing instruction to obtain a security tag; and
add the security tag to the container kernel data structure.

In accordance with the first aspect, signing and validation of kernel pointers and kernel data fields can be integrated into utility functions and macros for container kernel data structure which reduces integration and development efforts.

In an implementation form of a computer device according to the first aspect, the container kernel data structure is a hash table and wherein the security context is determined further based on a memory address of the hash table and/or an entry index in the hash table.

Accordingly, in some embodiments, during the determination of the security context for kernel data protection the actual use cases involving hash table are taken into consideration and solutions that best fit the intended use cases can be employed.

In an implementation form of a computer device according to the first aspect, the security context is a 64-bit value.

In some embodiments, the security context may be used directly as an input to the pointer authentication instructions.

In an implementation form of a computer device according to the first aspect, the signing instruction is a pointer authentication signing instruction.

In some cases, hardware-assisted security instructions can be fully utilized if the computer device architecture supports the pointer authentication instructions.

In an implementation form of a computer device according to the first aspect, the pointer authentication signing instruction is pointer authentication code data A, PACDA, for the kernel pointer and pointer authentication code generic A, PACGA, for the kernel data field.

In some embodiments, these pointer authentication instructions, which are often left unused in conventional solutions, can be fully utilized, so that both kernel pointers and kernel data fields can be protected by PACDA and PACGA, respectively.

In an implementation form of a computer device according to the first aspect, the computer device is configured to:
compress the kernel data field prior to signing the kernel data field to obtain a compressed kernel data field; and
sign the compressed kernel data field based on the security context and the signing instruction to obtain the security tag.

In some embodiments, kernel data fields longer than 64 bits can be protected by the pointer authentication instructions, which may require inputs to be at most 64 bit long. In addition, multiple kernel data fields in the same container kernel data structure may be protected as if they form a larger kernel data field when put together and compressed using this solution.

In an implementation form of a computer device according to the first aspect, the kernel data field is compressed into 64 bits.

In some embodiments, the compressed kernel data field can now be directly used as inputs to the pointer authentication instructions.

In an implementation form of a computer device according to the first aspect, adding the security tag to the container kernel data structure comprises:
append or prepend the security tag to the container kernel data structure; or
append or prepend the security tag to the kernel data field or the kernel pointer.

In some embodiments, implementers may choose the best method to store the security tag according to the intended use case of the container kernel data structures.

In an implementation form of a computer device according to the first aspect, the operating system is Linux.

In an implementation form of a computer device according to the first aspect, the container kernel data structure is part of a SELinux policy database and/or a SELinux Access Vector Cache.

In an implementation form of a computer device according to the first aspect, the computer device is configured to:
obtain a container kernel data structure comprising a security tag of a signed kernel data field or a signed kernel pointer;
determine a security context based on at least one of: a memory address of the container kernel data structure, a memory address of the kernel data field within the container kernel data structure, and a memory address of the kernel pointer within the container kernel data structure; and
validate the security tag based on the security context, a validation instruction, and the signed kernel data field or the signed kernel pointer.

In some embodiments, a validation procedure is provided thus enabling secure validation procedure to the protection procedure.

In an implementation form of a computer device according to the first aspect, the container kernel data structure is a hash table and wherein the security context is determined further based on a memory address of the hash table and/or an entry index in the hash table.

In an implementation form of a computer device according to the first aspect, the validation instruction is authentication data A, AUTDA, for the kernel pointer and PACGA for the kernel data field.

According to a second aspect of the disclosure, the present disclosure provides a method for protecting data of an operating system kernel, the method comprising:
determining a security context based on at least one of: a memory address of a container kernel data structure, a memory address of a kernel data field within the container kernel data structure, and a memory address of a kernel pointer within the container kernel data structure;
signing the kernel data field or the kernel pointer based on the security context and a signing instruction to obtain a security tag; and
adding the security tag to the container kernel data structure.

The method according to the second aspect can be extended into implementation forms corresponding to the implementation forms of the computer device according to the first aspect. Hence, an implementation form of the method comprises the feature(s) of the corresponding implementation form of the computer device.

In some embodiment, the advantages of the methods according to the third aspect are the same as those for the corresponding implementation forms of the computer device according to the first aspect.

Embodiments of the disclosure also relate to a computer program, characterized in program code, which when run by at least one processor causes the at least one processor to execute any method according to embodiments of the disclosure. Further, embodiments of the disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

### BRIEF DESCRIPTION OF THE DRAWINGS

The appended drawings are intended to clarify and explain different embodiments of the disclosure, in which:

FIG. 1 shows a computer device according to an exemplary embodiment of the disclosure;

FIG. 2 shows a flow chart of a method for a computer device according to an embodiment of the disclosure;

FIG. 3 shows an exemplary AVC hash table:

FIG. 4 illustrates kernel pointer and kernel data field signing according to embodiments of the disclosure:

FIG. 5 shows a diagram of protecting kernel data field pointers in a container kernel data structure according to embodiments of the disclosure:

FIG. 6 shows a diagram of protecting kernel data field in a container kernel data structure according to embodiments of the disclosure; and

FIG. 7 illustrates a compression function according to embodiments of the disclosure.

### DETAILED DESCRIPTION

As previously mentioned different types of kernel attacks have been identified. Yet another type of data-oriented kernel attacks exists, where the aim is to modify critical runtime kernel data structures that play critical roles in the path of making specific privilege decisions, so that the attacker may be granted privileges that should not be granted, or the attacker may be able to by-pass certain access control checks and able to access resources that were not accessible.

To protect kernel integrity, some conventional solutions make use of the availability of a hypervisor, which is a more privileged software stack compared to the kernel. Hypervisors may exist in many different CPU architectures, and an ARM CPU design architecture is used as an example since it is the widely used for consumer devices. In this ARM architecture, the hypervisor running in Exception Level 2 (EL2) maintains the memory mappings for lower exception levels and controls the access to the memory pages by lower levels. Therefore, it is possible to use the hypervisor to allocate a read-and-execute (RX) memory region for kernel executable code, and a read-only (RO) memory region to host static one-time programmable (OTP) data that should remain constant after initialization. A similar technique can be also applied to build a protected memory management module (PRMEM) in the kernel, so that data in protected memory regions are mapped as read-only to the kernel, but can be updated via direct data commands to the hypervisor. It should however be noted that such data commands are typically computationally expensive, making such protection method suitable only for data that changes only infrequently. On the other hand, we observe that latest ARMv8 instruction set architecture (ISA) provides security features that are not fully utilized for kernel protection. In particular, the ARMv8 ISA comes with a security extension called Pointer Authentication (PA). The instructions allow programs to compute a security tag on a pointer with a chosen security context and inserts the security tag in the unused bits located at the beginning of the pointer. When the pointers are used, these tags can be checked to see if the address contained in the pointers are modified.

Embodiments of the present disclosure among other things solve the problem of efficient protection of critical kernel data. In embodiments of the disclosure, the AVC of the SELinux subsystem in the Linux kernel is targeted as a concrete use case. However, embodiments of the disclosure are not limited thereto.

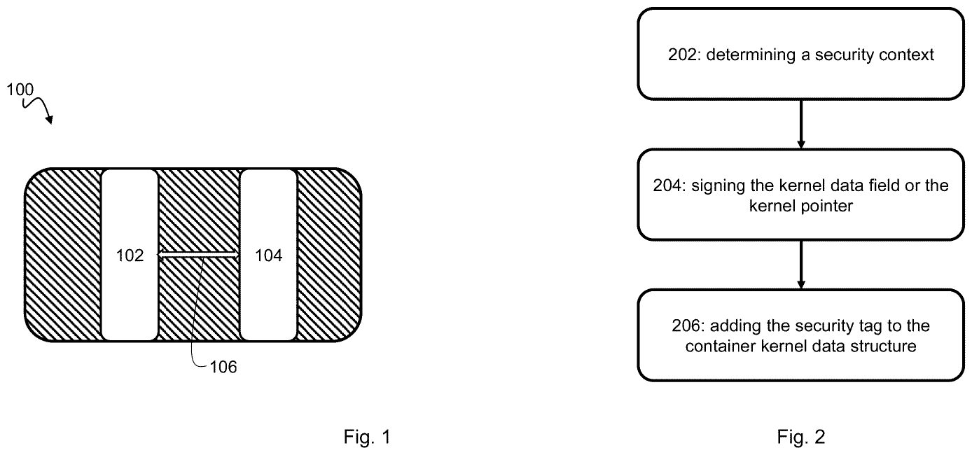

FIG. 1 shows a computer device 100 according to an embodiment of the disclosure. In the embodiment shown in FIG. 1, the computer device 100 comprises a processor 102 and a memory 104. The processor 102 is coupled to the memory 104 by communication means 106 known in the art. The computer device 100 may be may any suitable device such as mobile phones, tablets, PC, etc.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The memory 104 and/or the processor 102 may be implemented in separate chipsets or may be implemented in a common chipset.

According to embodiments of the disclosure, the computer device 100 is configured to determine a security context based on at least one of: a memory address of a container kernel data structure, a memory address of a kernel data field within the container kernel data structure, and a memory address of a kernel pointer within the container kernel data structure; sign the kernel data field or the kernel pointer based on the security context and a signing instruction to obtain a security tag; and add the security tag to the container kernel data structure.

Furthermore, in an embodiment of the disclosure, the computer device 100 comprises a processor configured to: determine a security context based on at least one of: a memory address of a container kernel data structure, a memory address of a kernel data field within the container kernel data structure, and a memory address of a kernel pointer within the container kernel data structure; sign the kernel data field or the kernel pointer based on the security context and a signing instruction to obtain a security tag; and add the security tag to the container kernel data structure.

Moreover, in yet another embodiment of the disclosure, the computer device 100 comprises a processor and a memory having computer readable instructions stored thereon which, when executed by the processor, cause the processor to: determine a security context based on at least one of: a memory address of a container kernel data structure, a memory address of a kernel data field within the container kernel data structure, and a memory address of a kernel pointer within the container kernel data structure; sign the kernel data field or the kernel pointer based on the security context and a signing instruction to obtain a security tag; and add the security tag to the container kernel data structure.

FIG. 2 shows a flow chart of a corresponding method 200 which may be executed in a computer device 100, such as the one shown in FIG. 1. The method 200 comprises determining 202 a security context based on at least one of: a memory address of a container kernel data structure, a memory address of a kernel data field within the container kernel data structure, and a memory address of a kernel pointer within the container kernel data structure; signing 204 the kernel data field or the kernel pointer based on the security context and a signing instruction to obtain a security tag; and adding 206 the security tag to the container kernel data structure.

The security context may be a binary value such as a 64-bit value in embodiments of the disclosure. Moreover, the container kernel data structure is in embodiments of the disclosure a hash table and thus the security context may be determined further based on a memory address of the hash table and/or an entry index in the hash table as will be described in the following disclosure.

The signing instruction used in the disclosed solution may be a pointer authentication signing instruction according to embodiments of the disclosure. More specifically, the pointer authentication signing instruction may be pointer authentication code data A (PACDA) for the kernel pointer and pointer authentication code generic A (PACGA) for the kernel data field.

Adding the security tag to the container kernel data structure may in a first alternative mean to append or prepend the security tag to the container kernel data structure. However, in a second alternative adding the security tag to the container kernel data structure may mean to append or prepend the security tag to the kernel data field or the kernel pointer.

Embodiments of the disclosure also relates to the procedure of validating or authenticating protected kernel data. Thus, the computer device 100 may also be configured to obtain a container kernel data structure comprising a security tag of a signed kernel data field or a signed kernel pointer; determine a security context based on at least one of: a memory address of the container kernel data structure, a memory address of the kernel data field within the container kernel data structure, and a memory address of the kernel pointer within the container kernel data structure; and validate the security tag based on the security context, a validation instruction, and the signed kernel data field or the signed kernel pointer.

The validation instruction used may be authentication data A (AUTDA) for the kernel pointer and PACGA for the kernel data field.

As previously mentioned, the container kernel data structure may be represented as a hash table and in such cases the security context for the validation procedure may be determined further based on a memory address of the hash table and/or an entry index in the hash table.

Furthermore, to provide even deeper understanding of the disclosed solution further embodiments of the disclosure will be presented in a Linux kernel context, with the SELinux enabled, is run on a computing device with an ARM CPU that supports the PA security extension and a hypervisor running in EL2. However, embodiments of the disclosure are not limited thereto.

Thus, it is examined the consideration of protecting the SELinux subsystem in the Linux kernel which implies that the operating system is Linux and the container kernel data structure is part of a SELinux policy database and/or a SELinux access vector cache (AVC) in embodiments of the disclosure.

The SELinux subsystem in the Linux kernel is responsible for controlling the access to system resources by applications based on a security policy defined by a system administrator. The SELinux policy is compiled into a binary form beforehand and is loaded into the kernel during an early stage when the kernel is booted. The policy data is stored in a kernel data structure that is often referred to as a SELinux policy database. The SELinux policy database will remain unchanged until a new SELinux policy is loaded. In many consumer devices such as Android devices, policy re-loading is not allowed.

When an application process is trying to access a protected system resource, the SELinux subsystem is consulted to determine if the access should be allowed. To speed up the access checking, an AVC is used. The SELinux subsystem would first lookup the AVC to see if there are any matching records where the decision has been made before. If the records are not found in the cache, the SELinux subsystem would then check the SELinux policy database to make an access control decision and record the result in the AVC for future use. If the AVC already has too many records, an algorithm is run to evict some entries in the cache to reduce its size.

As noted, both the SELinux policy database and the AVC contain critical data that needs to be protected to maintain the integrity of the access control mechanism. The difference is that the policy database does not change often if at all, but the cache may need frequent updates.

In particular, the following non-limiting devices/units/entities of the Linux system are herein considered:
A computing device 100, integrated with an ARM CPU with hypervisor and pointer authentication features. The computing device 100 is also equipped with memory and other components to run a Linux operating system.
A hypervisor, hosted on the computing device 100, runs in a more privileged level compared with the operating system kernel, and is responsible for enforcing memory mapping attributes for the kernel memory access control.
A Linux kernel, hosted on the computing device 100, is the most essential component of the Linux operating system. We assume that the SELinux subsystem and the pointer authentication feature are enabled in the kernel.
An SELinux subsystem in the Linux kernel, responsible for deciding if a software component in the system, such as a user space application process, should be granted access to a specific system resource, such as a file, according to a given policy. The SELinux subsystem contains a policy database that stores the policy in memory, an access vector cache (AVC) to speed up policy lookup, and corresponding logic to make access decisions and to manage the policy database and AVC in the memory. The SELinux subsystem is an example of a data owner, who manages some data content in the memory.
A data protector, a software component within the Linux kernel, responsible for protecting data in the memory managed by a data owner.

### Kernel Pointers and Kernel Data Fields

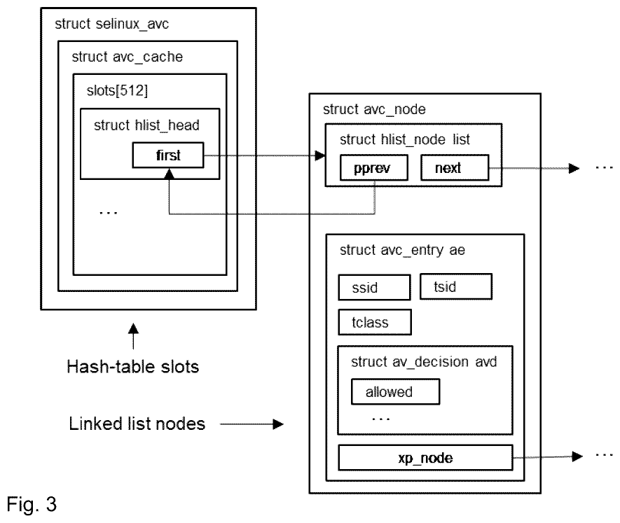

In this section, we focus our discussions on the AVC of the SELinux subsystem in the Linux kernel. In essence, the AVC is simply a hash table, where each table entry is backed by a double-linked list. The container kernel data structure involved in the hash table and the linked lists are illustrated in FIG. 3 which shows the hash table where shade is pointers and arrows are illustrating memory addresses. Note that in FIG. 3 we have omitted many details in the kernel code but instead focus on the main structure.

The first thing we observe is that to maintain the integrity of the AVC, a number of kernel data items needs to be considered. First, there are pointers that are used to construct the hash table. These include the ‘first’ pointer in struct hlist_head, which is the start of the linked list in every hash table slot. This ‘first’ pointer points to (i.e., contains the address of) another structure, struct hlist_node, that represents a node in the linked list. Each node in turns contains two more pointers, ‘pprev’ and ‘next’, which point to the ‘first’ or ‘next pointer of the previous node and the next node in the linked list respectively. The integrity of the hash table may naturally require that these pointers need to be protected. Note that these data structures are provided in the kernel as one of the fundamental data structures that are used by many components in the kernel. In other words, the method to protect these pointers would easily apply to other kernel components that also use such data structures.

Secondly, there are also other pointers, such as the ‘xp_node’ pointer in FIG. 3, which points to other data structures that would be used by the AVC.

Thirdly, the data field ‘allowed in ‘struct av_decision’ inside each AVC entry also needs to be protected, since this data field contains the actual access decisions made during some previous operations of the SELinux subsystem. Other data fields such as ‘ssid’ and ‘tsid’ can also be protected in similar ways but their importance is lower.

To protect a pointer, we can directly use one of the pointer-signing and validation instructions, such as PACDA and AUTDA. Recall that each such signing and validation instructions may require an extra parameter called the security context also sometimes denoted modifier. For pointer signing, there are a few options for the choice of the security context as follows.
1. Use a constant security context (e.g., value 0). This allows the pointer to be copied to any other location and still can be validated by pointer validation/authentication instructions.
2. Use the memory address of the pointer as the security context. This has the effect of pinning the pointer to the current memory location. Copying the signed pointer to any other location would render it invalid.
3. Use the memory address of the container kernel data structure. This has the effect of pining the pointer to the container kernel data structure. Copying of the pointer within the same container kernel data structure makes it still valid, but copying it to another container kernel data structure would invalidate it.
4. Use one of the kernel data fields in the same container kernel data structure as the pointer. This has the effect of binding the pointer with the data field.
5. Any other sensible value from the context. For example, for the ‘first pointer in each hash table index, we can use a memory address of the hash table identifier plus the entry index as the security context when container kernel data structure is a hash table. This would allow the entire hash table to be copied to other locations without invalidating the pointers.

To protect a data field, we can use the PACGA generic signing instruction, which produces a 32-bit tag given a 64-bit input data and a 64-bit modifier. However, more effort may be required for data fields since firstly we need to make some room to store the computed security tag, and secondly the data field may be longer than 64 bits and cannot fit into one signing or validation instruction.

For the second problem we need to use a compression function to reduce the data field to be signed to be within 64 bits. The details of the compression function will be given in the following disclosure. For now, we just assume that the data field to be signed is always at most 64-bit long and thus can fit into one signing or validation instruction. There two ways to store the computed security tag as follows.
1. Expand the data field to be signed to accommodate the security tag. For example, if the data field is 32-bit long, we can replace it with a 64-bit data field so that we have 32 bits for the security tag. If the data field is already 64-bit long, we can add an extra data field immediately before or after the data field to be signed to hold the tag. This is useful when there are multiple data fields to be protected independently in a container kernel data structure.
2. Expand the container kernel data structure by 32 bits. This does not require changes to the definition of the container kernel data structure, but instead we can allocate extra 4 bytes each time when allocating memory for the target container kernel data structure, and use the first 4 bytes (i.e., 32 bits) to store the tag. For example, if the size of a data structure is 70 bytes, we can allocate 74 bytes when allocating memory for the container kernel data structure, and write the program as if the container kernel data structure starts from the 5-th byte of the allocated memory. This is useful when there are multiple data fields to be protected together. In some embodiments, this method also provides that the protection can be transparent to many of the common operations to the container kernel data structure, since the security tag is somewhat hidden.

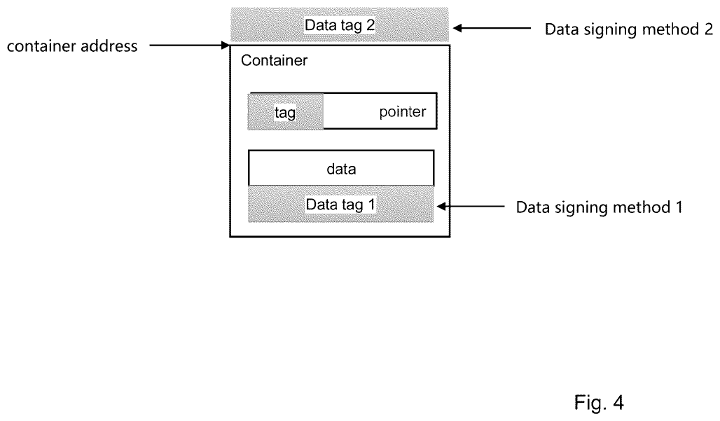

The pointer and data protection methods are further illustrated in FIG. 4 which illustrates how the computed security tag may be stored. The security tag resulted from a pointer-signing instruction such as PACDA is inserted into unused high bits of the kernel pointer. The box labelled ‘data tag 1’ uses the first method “Expand the data field . . . ” above and shows the case where the security tag is appended to the kernel data field to be protected. The box labelled ‘data tag 2’ users the second method “Expand the container kernel data structure . . . ” above and shows the case where the security tag is prepended to the container data structure.

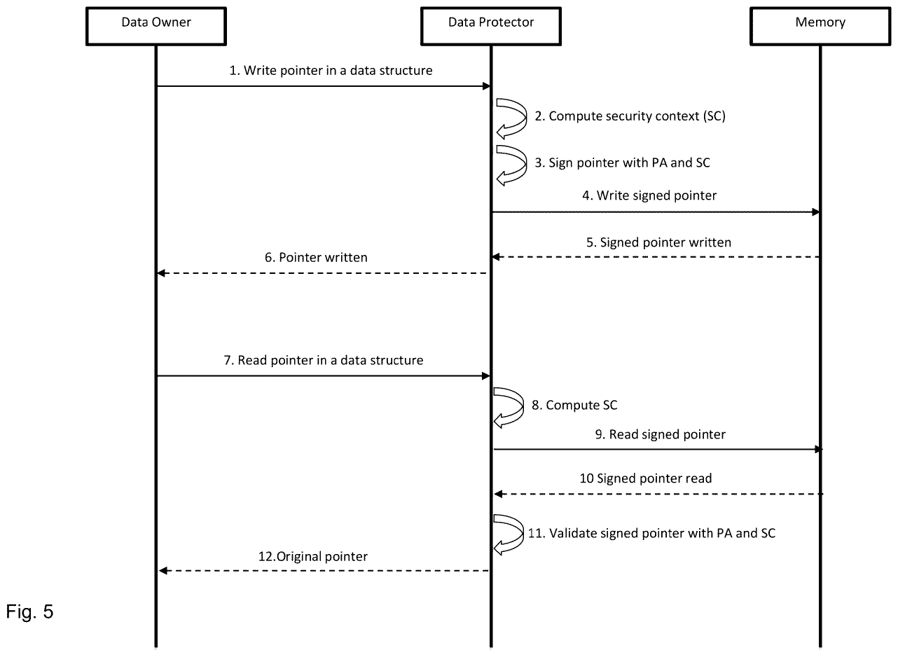

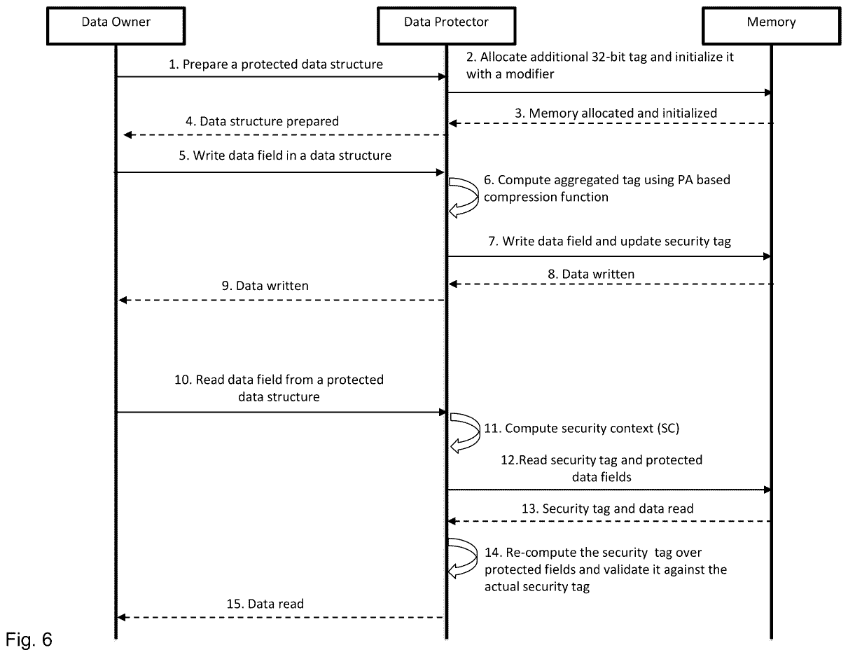

The process of signing of the pointers before storing them in a container kernel data structure and that of validating pointers before using are further illustrated with the diagram in FIG. 5. In this diagram, the Data Owner refers to a software component that is responsible for the management of the data to be protected, and the Data Protector refers to the code that does the protection. The Data Protector can be implemented such that the code can be used by many components (data owners) in the kernel. It may be noted that the dotted lines in FIGS. 5 and 6 represents results of corresponding steps.

Instead of directly writing the pointer to be protected to the memory, the data owner instead requests the data protector to write it on behalf of the data owner in Step 1. The data protector then computes a security context in Step 2 according one of the methods mentioned earlier and signs the pointer in Step 3 using one of the pointer authentication instructions, such as PACDA, and store the signed pointer in the memory location specified by the data owner in Steps 4 and 5. The data write operation that started in Step 1 is completed in Step 6.

When using the pointer, the data owner requests the data protector to read and validate the pointer from a specific location in Step 7. The data protector computes the security context in the same way as before in Step 8, reads the signed pointer from the specified memory location in Step 9, and validates the signed pointer in Step 11 using the corresponding pointer authentication instruction, such as AUTDA, before returning the original pointer to the data owner.

Similarly, the processes of signing and validating a data field in a container kernel data structure are illustrated in FIG. 6. Although similar to pointer signing, the processes for data field protection may require an extra preparation Step 1 to allocate memory to store the computed security tag. We initialize the security tag to be the security context that we compute using one of the methods mentioned earlier in Steps 2 and 3. The reason for using the security tag location to host the security context will become clearer later. The data write operation that started in Step 1 is completed in Step 4.

When writing the data fields to be protected, the data protector processes the data fields in a specific sequence. For each data field, Steps 5-9 are followed, where the data protector computes a new security tag by applying a compression function in Step 6, using the existing security tag as the security context. The new security tag is then updated in the location that we reserved for the security tag in the preparation step in Step 7. Similarly, when reading protected fields from the memory in Steps 10-15, we need to repeat the steps above to compute the security tag and match it against the security tag stored in the memory in Steps 11-14. An exception will be raised if the security tags differ.

It should be noted that it is possible to sign pointers as if they are data fields. The difference is that the security tag resulted from pointer signing will be directly inserted into the unused bits of the pointer, whereas the security tag computed using data signing method will be stored separately. Signing pointers without changing their unused bits may be desirable in certain scenarios.

It should also be noted that, the use of various container kernel data structures, especially those provided as common utilities in the kernel, such as hash tables, linked lists and so on, is typically via utility functions and macros. As a result, the implementation of the data protector should take this into the consideration and encapsulate as much as possible the signing and validation operations within the utility functions and macros. This will greatly reduce the cost of software integration and kernel development.

### Compression

As mentioned previously kernel data field may have to be compressed prior to signing the kernel data field to obtain a compressed kernel data field. The compressed kernel data field is thereafter signed based on the security context and the signing instruction to obtain the security tag. In this respect a compression function may be used that securely reduces the size of the data field to be signed to be within 64 bits if the original data is longer. In the pointer authentication extension of the ARMv8 ISA, the generic signing instruction PACGA can be considered as a function:

$$T = P A C G A ( D , M )$$

where D and M are at most 64-bit long and T is a 32-bit value. This instruction is particularly useful in constructing a compression function. In a prior art a compression function is given as

$$Compress ( {V}_{1} , {V}_{2} ) = P A C G A ( {V}_{1} , 0 ) \vert P A C G A ( {V}_{2} , 0 )$$

where the vertical bar (′|′) represents data concatenation. This function reduces 128-bit data (V₁ V₂) to 64-bit long (concatenation of two 32-bit values). In this section we give a new security context-aware compression function that is suitable for our purposes. We first define it recursively as follows.

$$Compress ( {V}_{1} , {V}_{2} , … , {V}_{n} , M ) = Compress ( {V}_{1} , {V}_{2} , … , {V}_{n - 1} , PACGA ( {V}_{n} , M ) )$$

$$Compress ( {V}_{1} , X ) = P A C G A ( {V}_{1} , X )$$

In other words, to compress the data fields V₁, V₂, . . . , Vₙ with a security context M, we apply the PACGA function repeatedly on each data field, assuming all of the data fields are at most 64-bit long, using the security tag computed from the previous round as the security context. Interestingly, the result of the compression function is a security tag computed from the PACGA function, which can be directly used as the security tag for protecting the data fields without an extra step to compute it. This explains why we initialize the security tag for a protected data structure as the initial modifier.

An alternative view of the above compression function, after we reverse the order of the subscripts of the data fields, is as follows.

$$Compress ( {V}_{1} , {V}_{2} , … , {V}_{n} , M ) = P A C G A ( {V}_{n} , PACGA ( {V}_{n - 1} , … PACGA ( {V}_{2} , PACG A ( {V}_{1} , M ) ) ) )$$

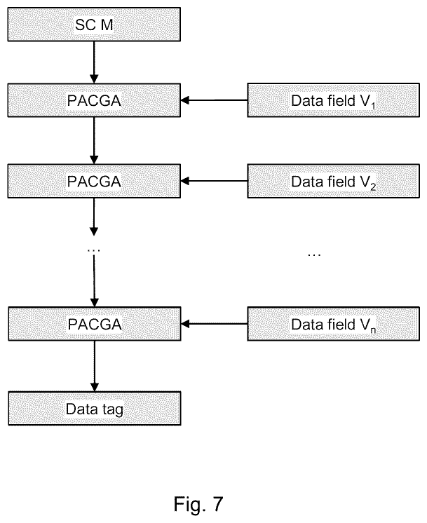

These two views are equivalent technically. We further illustrate this function in FIG. 7 which shows how a PACGA is 32 bits but can be stored in a 64-bit memory and thus used in the next compression step. FIG. 7 shows how such a compression function may be implemented. In particular, we first divide the kernel data fields to be protected into n number of values, each not exceeding 64-bit, and apply the PACGA instruction on these values one by one. Note that the PACGA instruction takes a security context and a data value as inputs, and produces a security tag as output. The first round employs the initial computed security context as the security context input to the PACGA instruction, but subsequent rounds uses the security tag computed in the previous round as the security context input to the PACGA instruction.

### SELinux Policy Database

It has previously been described how to protect the AVC of the SELinux subsystem. For completeness, we note that the SELinux policy database should also be protected. Hypervisor based methods are more suitable to protect these data structures, since they only change when we initialize or reload the SELinux policy. In this case, we can build or re-build the policy database first in an unprotected memory region, and then make it read-only using conventional techniques. This would be more efficient than protecting each data structure individually. To achieve this, we need to modify the secure memory manager in conventional techniques in such a way that it allows us to allocate a secure memory region without protection first, and enable the protection only after some time.

Furthermore, when policy reloading is allowed in the system, applying conventional techniques in this way would result in a small time-window where the memory region is unprotected. To avoid vulnerabilities during this time-window, we can combine the disclosed solution with the conventional techniques as follows during policy reload.
1. Allocate a memory region for the new policy database using the modified secure memory manager but leave the memory unprotected initially.
2. Build the policy database using the disclosed solution, where pointers are signed as data to avoid modifying the unused bits.
3. Make the memory region protected (read-only) using the modified secure memory manager after the database has been built.
4. Validate all the security tags computed during Step 2.
5. Use the policy database as usual without further validating the security tags.

By applying these steps, we can avoid vulnerabilities during the policy reload process, without introducing runtime overhead after the reload. The extra steps to compute and validate security tags in Steps 2 and 4 are typically acceptable since the reload happens infrequently. Note that although it is possible to use the secure memory manager as-is, this may require data commands to be sent to the hypervisor whenever the memory region is modified during the reloading of the policy. This would still result in too much overhead and not acceptable in practice.

Furthermore, any method according to embodiments of the disclosure may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the computer device 100 comprise the communication capabilities in the form of e.g., functions, means, units, elements, etc., for performing or implementing embodiments of the disclosure. Examples of other such means, units, elements and functions are: processors, memory, buffers, control logic, power supply units, power feeders, communication interfaces, communication protocols, etc. which are suitably arranged together for performing the solution.

Therefore, the processor(s) of the computer device 100 may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the disclosure is not limited to the embodiments described above, but also relates to and incorporates all embodiments within the scope of the appended independent claims.

What is claimed is:

1. A computer device for protecting data of an operating system kernel, the computing device comprising at least one processor and being configured to:
determine a security context based on at least one of: a memory address of a container kernel data structure, a memory address of a kernel data field within the container kernel data structure, and a memory address of a kernel pointer within the container kernel data structure;
sign the kernel data field or the kernel pointer based on the security context and a signing instruction to obtain a security tag; and
add the security tag to the container kernel data structure.

2. The computer device according to claim 1, wherein the container kernel data structure is a hash table and wherein the security context is determined further based on a memory address of the hash table and/or an entry index in the hash table.

3. The computer device according to claim 1, wherein the security context is a 64-bit value.

4. The computer device according to claim 1, wherein the signing instruction is a pointer authentication signing instruction.

5. The computer device according to claim 4, wherein the pointer authentication signing instruction is pointer authentication code data A (PACDA) for the kernel pointer and pointer authentication code generic A (PACGA) for the kernel data field.

6. The computer device according to claim 1, configured to:
compress the kernel data field prior to signing the kernel data field to obtain a compressed kernel data field; and
sign the compressed kernel data field based on the security context and the signing instruction to obtain the security tag.

7. The computer device according to claim 6, wherein the kernel data field is compressed into 64 bits.

8. The computer device according to claim 1, wherein adding the security tag to the container kernel data structure comprises:
append or prepend the security tag to the container kernel data structure; or
append or prepend the security tag to the kernel data field or the kernel pointer.

9. The computer device according to claim 1, wherein the operating system is Linux.

10. The computer device according to claim 9, wherein the container kernel data structure is part of a SELinux policy database and/or a SELinux Access Vector Cache.

11. The computer device according to claim 1, configured to:
obtain a container kernel data structure comprising a security tag of a signed kernel data field or a signed kernel pointer;
determine a security context based on at least one of: a memory address of the container kernel data structure, a memory address of the kernel data field within the container kernel data structure, and a memory address of the kernel pointer within the container kernel data structure; and
validate the security tag based on the security context, a validation instruction, and the signed kernel data field or the signed kernel pointer.

12. The computer device according to claim 11, wherein the container kernel data structure is a hash table and wherein the security context is determined further based on a memory address of the hash table and/or an entry index in the hash table.

13. The computer device according to claim 11, wherein the validation instruction is authentication data A (AUTDA) for the kernel pointer and PACGA for the kernel data field.

14. A method for protecting data of an operating system kernel, the method comprising:
determining a security context based on at least one of: a memory address of a container kernel data structure, a memory address of a kernel data field within the container kernel data structure, and a memory address of a kernel pointer within the container kernel data structure;
signing the kernel data field or the kernel pointer based on the security context and a signing instruction to obtain a security tag; and
adding the security tag to the container kernel data structure.

15. A tangible, non-transitory computer readable storage medium comprising program instructions or logic, which when executed by one or more processors cause the one or more processors to execute a method for protecting data of an operating system kernel, the method comprising:
determining a security context based on at least one of: a memory address of a container kernel data structure, a memory address of a kernel data field within the container kernel data structure, and a memory address of a kernel pointer within the container kernel data structure;
signing the kernel data field or the kernel pointer based on the security context and a signing instruction to obtain a security tag; and
adding the security tag to the container kernel data structure.

16. The method according to claim 14, wherein the container kernel data structure is a hash table and wherein the security context is determined further based on a memory address of the hash table and/or an entry index in the hash table.

17. The method according to claim 14, wherein the signing instruction is a pointer authentication signing instruction.

18. The method according to claim 17, wherein the pointer authentication signing instruction is pointer authentication code data A (PACDA) for the kernel pointer and pointer authentication code generic A (PACGA) for the kernel data field.
